(19) United States
(12) Patent Application Publication
(10) Pub. No.: US 2025/0351043 A1
(43) Pub. Date: Nov. 13, 2025

(54) SYSTEM AND METHOD FOR ANALYZING NETWORK PERFORMANCE BASED ON CELL ID

(71) Applicant: JIO PLATFORMS LIMITED, Ahmedabad (IN)

(72) Inventors: Aayush BHATNAGAR, Navi Mumbai (IN); Pradeep Kumar BHATNAGAR, Navi Mumbai (IN); Sundaresh SANKARAN, Mumbai (IN); Haresh B AMBALIYA, Gujarat (IN); Makarand Sushil DERE, Maharashtra (IN); Anil GUPTA, Madhya Pradesh (IN); Aishwary JAIN, Madhya Pradesh (IN); Vikram SINGH, Navi Mumbai (IN)

(73) Assignee: JIO PLATFORMS LIMITED, Ahmedabad (IN)

(21) Appl. No.: 18/993,280

(22) PCT Filed: May 21, 2024
(86) PCT No.: PCT/IN2024/050593

§ 371 Date: Jan. 10, 2025

(30) Foreign Application Priority Data
Jun. 28, 2023 (IN) 202321043266

(51) Int. Cl. H04W 36/30; H04B 17/309; H04W 64/00

(52) U.S. Cl. CPC H04W 36/304; H04B 17/309; H04W 64/00

(57) ABSTRACT

The present disclosure provides a system (108) and a method (300) for analyzing network performance based on the cell ID. By examining the specific cell's network performance, the system allows operators to identify and optimize any existing issues within that cell. The analysis is also extended to customer care support, providing agents with valuable information to address customer concerns related to the specific cell. The system analyzes various aspects of the network, including barring, congestion, outage, and interference, to identify potential issues and their corresponding resolutions. This analysis helps build trust between the operator and customers, improves customer satisfaction, and reduces call volume and costs for the company.

### RESERVATION OF RIGHTS

A portion of the disclosure of this patent document contains material, which is subject to intellectual property rights such as but are not limited to, copyright, design, trademark, integrated circuit (IC) layout design, and/or trade dress protection, belonging to Jio Platforms Limited (JPL) or its affiliates (hereinafter referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### FIELD OF INVENTION

The present disclosure generally relates to systems and methods analyzing network performance in a wireless telecommunications network. More particularly, the present disclosure relates to a system and a method for analyzing network performance of cell id, to improve customer satisfaction.

### DEFINITION

As used in the present disclosure, the following terms are generally intended to have the meaning as set forth below, except to the extent that the context in which they are used to indicate otherwise.

The expression ‘operative state of a network cell’ used hereinafter in the specification refers to a current operational status or condition of a network cell. The operative state indicates whether the network cell is actively functioning, available for use by users, and capable of transmitting and receiving signals. In the context of cellular networks, the operative state of the network cell is crucial for providing uninterrupted communication services to subscribers within its coverage area.

The expression ‘congested state’ used hereinafter in the specification refers to a condition in which a network cell experiences high levels of traffic or usage, resulting in decreased performance and potential delays or disruptions in communication for users within the coverage area of the network cell.

The expression ‘barred state’ used hereinafter in the specification refers that access to a particular network cell is restricted or barred, often due to security measures, network configuration settings, or limitations imposed by the service provider. Mobile devices may be prevented from connecting to the network cell or accessing its services in this state.

The expression ‘outage state’ used hereinafter in the specification refers to a condition where a network cell is temporarily or completely unavailable for communication services. This could be due to technical issues, equipment failure, maintenance activities, or external factors such as severe weather conditions.

The expression ‘coverage state’ used hereinafter in the specification refers to quality of signal coverage provided by a network cell within its designated area. A cell in a “good coverage state” indicates that it is effectively providing signal coverage to mobile devices within its intended range, while a “poor coverage state” suggests areas where signal strength may be weaker or intermittent.

The expression ‘interference state’ used hereinafter in the specification refers to a condition where unwanted signals or electromagnetic interference degrade the quality of communication within a network cell. Interference can arise from various sources such as nearby electronic devices, competing wireless networks, or environmental factors, leading to reduced signal strength and potential communication errors.

The expression ‘extent of the determined operative state’ used hereinafter in the specification refers to a degree or level to which a particular cellular network cell is functioning or operational.

These definitions are in addition to those expressed in the art.

### BACKGROUND OF THE INVENTION

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admission of the prior art.

In today's highly connected world, reliable network performance is crucial for smooth communication and efficient data transmission. Mobile network operators strive to provide optimal network performance to their customers, ensuring seamless connectivity and high-quality services.

Traditional methods for analyzing network performance have relied on a combination of manual inspections, drive testing, key performance indicators (KPIs), network monitoring tools, field technicians, and customer complaints. These methods provide valuable insights into network performance but often require significant time, resources, and manual effort. Drive testing involves physically driving through various locations to collect data on network parameters, while KPIs and network monitoring tools offer quantitative measurements at a network-wide level. Field technicians are dispatched to troubleshoot issues on-site, and customer complaints provide feedback on network problems. However, these methods may lack real-time insights, cell-level analysis, and proactive issue identification.

There is, therefore, a need in the art to provide a system and a method that can mitigate the problems associated with the prior arts.

### Objects of the Invention

It is an object of the present disclosure to provide a system and a method by automating the network analysis process, the system saves significant time and resources compared to manual inspections, drive testing, and field technician visits, also the analysis is performed in real-time, allowing for proactive issue identification and resolution.

It is an object of the present disclosure to provide a system and a method that focuses specifically on the performance of individual cells, and cell-level analysis allows for a more granular understanding of network issues, enabling targeted optimizations and improvements.

It is an object of the present disclosure to provide a system and a method that is able to identify probable serving cells and analyze various network parameters, issues can be detected proactively, and monitoring aspects like barring, outage, congestion, and interference, potential problems can be identified before they impact the network performance or customer experience.

It is an object of the present disclosure to provide a system and a method that provides agents with accurate and up-to-date information about network issues and resolutions and enables them to provide prompt and relevant assistance to customers, reducing the number of calls to the care centre and improving customer satisfaction.

It is an object of the present disclosure to provide a system and a method that automate network analysis process and enabling proactive issue identification, the system helps reduce operational costs, and minimizes the need for manual inspections, drive testing, and field technician visits, leading to cost savings for the network operator.

### SUMMARY

The present disclosure discloses a system for analyzing real-time performance of at least one network cell. The system includes a receiving unit, a memory, at least one source, and a processing unit. The receiving unit is configured to receive a location information of a user equipment using a location application programming interface (API). The memory is configured to store a plurality of predefined cell identities (IDs) and a plurality of cell location information corresponding to a plurality of network cells. The at least one source is configured to store a plurality of handover information and a plurality of signal quality metric information corresponding to the plurality of network cells. The processing unit is configured to cooperate with the receiving unit (220), the memory (204), and the at least one source. The processing unit is further configured to retrieve a cell ID corresponding to a network cell associated with the user equipment by using the received location information of the user equipment and the stored plurality of cell location information. The processing unit is configured to identify at least one neighboring cell to the network cell associated with the user equipment, by utilizing a handover information corresponding to the retrieved cell ID. The processing unit is configured to analyze a plurality of performance attributes associated with the at least one neighboring cell and the network cell of the retrieved cell ID, by utilizing the plurality of signal quality metric information associated with the neighboring cells and the network cell of the retrieved cell ID.

In an embodiment, the plurality of performance attributes includes barring, outage, congestion, and interference.

In an embodiment, the system is further configured to determine at least one operative state of the network cell of the retrieved cell ID based on the analyzed plurality of performance attributes.

In an embodiment, the at least one determined operative state is a congested state, a barred state, an outage state, and an interference state.

In an embodiment, the system is further configured to determine an extent of the at least one determined operative state and provide at least one resolution corresponding to the at least one determined operative state based on the determined extent.

In an embodiment, for determining the barred state, the processing unit is configured to map the retrieved cell ID with a list having cell IDs corresponding to barred network cells in a network.

In an embodiment, for determining the outage state, the processing unit (208) is configured to map the retrieved cell ID with a list having cell IDs having active outage in the network stored in the memory.

In an embodiment, for determining the congested state, the processing unit (208) is configured to map the retrieved cell ID with a list having cell IDs corresponding to congested network cells in the network stored in the memory.

In an embodiment, for determining the interference state, the processing unit (208) is configured to map the retrieved cell ID with a list having cell IDs having interference stored in the memory.

In an embodiment, the system is configured to provide the at least one resolution by considering at least one or more of the at least one operative state, historical data representing reoccurrence of the at least one operative state, and current network conditions.

In an embodiment, the handover information includes a number of handover attempts by the retrieved cell ID.

In an embodiment, the at least one source is one of an operational support system (OSS), a unified data repository (UDR), and a plurality of network functions.

In an embodiment, the plurality of signal quality metric information includes active barred site details, reference signal received power (RSRP), reference signal received quality (RSRQ), and signal-to-interference-plus-noise ratio (SINR).

In an embodiment, the system includes a display unit configured to display the at least one determined operative state of the network cell and the suggested at least one resolution.

In an embodiment, the system, is configured to store the at least one determined operative state and the plurality of analyzed performance attributes in the memory along with a time stamp.

The present disclosure discloses a method of analyzing real-time performance of at least one network cell. The method includes receiving a location information of a user equipment using a location application programming interface (API). The method includes retrieving a cell ID corresponding to a network cell associated with the user equipment by using the received location information of the user equipment and a plurality of cell location information stored in a memory. The method includes identifying at least one neighboring cell to the network cell associated with the user equipment, by utilizing a handover information corresponding to the retrieved cell ID. The method includes analyzing a plurality of performance attributes associated with the at least one neighboring cell and the network cell of the retrieved cell ID, by utilizing the plurality of signal quality metric information associated with the neighboring cells and the network cell of the retrieved cell ID.

In an embodiment, the method includes determining at least one operative state of the network cell of the retrieved cell ID based on the plurality of analyzed performance attributes.

In an embodiment, the method includes determining an extent of the at least one determined operative state and provides at least one resolution corresponding to the at least one determined operative state based on the determined extent.

In an embodiment, the method includes storing a plurality of handover information and a plurality of signal quality metric information corresponding to the plurality of network cells in at least one source.

In an embodiment, the handover information includes a number of handover attempts by the retrieved cell ID.

In an embodiment, the at least one source is one of an operational support system (OSS), a unified data repository (UDR), and a plurality of network functions.

In an embodiment, the plurality of signal quality metric information includes active barred site details, reference signal received power (RSRP), reference signal received quality (RSRQ), and signal-to-interference-plus-noise ratio (SINR).

In an embodiment, the plurality of performance attributes includes barring, outage, congestion, and interference.

In an embodiment, the at least determined one operative state is a congested state, a barred state, an outage state, and an interference state.

In an embodiment, the method includes displaying the at least one determined operative state of the network cell and the suggested at least one resolution on a display unit.

In an embodiment, the method includes storing the at least one determined operative state and the plurality of analyzed performance attributes in the memory along with a time stamp.

The present disclosure discloses a user equipment configured to analyze real-time performance of at least one network cell. The user equipment includes a processor and a computer readable storage medium storing programming instructions for execution by the processor. Under the programming instructions, the processor is configured to receive a location information of the user equipment using a location application programming interface (API). Under the programming instructions, the processor is configured to store, in the computer readable storage medium, a plurality of cell IDs along and a plurality of locations corresponding to a plurality of network cells. Under the programming instructions, the processor is configured to retrieve, by the processor, a cell ID corresponding to a network cell associated with the user equipment by using the received location information of the user equipment and the stored plurality of cell location information. Under the programming instructions, the processor is configured to identify, by the processor, at least one neighboring cell to the network cell associated with the user equipment, by utilizing a handover information corresponding to the retrieved cell ID stored in at least one source, wherein the at least one source further stores a plurality of signal quality metric information corresponding to the plurality of network cells. Under the programming instructions, the processor is configured to analyze, by the processor, a plurality of performance attributes associated with the at least one neighboring cell and the network cell of the retrieved cell ID, by utilizing the plurality of signal quality metric information associated with the neighboring cells and the network cell of the retrieved cell ID.

### BRIEF DESCRIPTION OF DRAWINGS

The accompanying drawings, which are incorporated herein, and constitute a part of this disclosure, illustrate exemplary embodiments of the disclosed methods and systems which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes the disclosure of electrical components, electronic components, or circuitry commonly used to implement such components.

FIG. 1 illustrates an example network architecture for implementing a system for analyzing real-time performance of at least one network cell, in accordance with an embodiment of the present disclosure.

FIG. 2 illustrates an example block diagram of the system, in accordance with an embodiment of the present disclosure.

FIG. 3 illustrates an example flow diagram for analyzing real-time performance of at least one network cell, in accordance with an embodiment of the present disclosure.

FIG. 4 illustrates an example computer system in which or with which the embodiments of the present disclosure may be implemented.

The foregoing shall be more apparent from the following more detailed description of the disclosure.

### LIST OF REFERENCE NUMERALS

100—Network Architecture
102-1, 102-2 . . . 102-N—Operators
104-1, 104-2 . . . 104-N—Computing Devices
106—Network
108—System
204—Memory
206—A Plurality of Interfaces
208—Processing Unit
210—Database
212—Network Analysis Module
214—Barring Analysis Module
220—Receiving Unit
410—External Storage Device
420—Bus
430—Main Memory
440—Read Only Memory
450—Mass Storage Device
460—Communication Port
470—Processor

### DETAILED DESCRIPTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address any of the problems discussed above or might address only some of the problems discussed above. Some of the problems discussed above might not be fully addressed by any of the features described herein. Example embodiments of the present disclosure are described below, as illustrated in various drawings in which like reference numerals refer to the same parts throughout the different drawings.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process that is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive like the term “comprising” as an open transition word without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is to describe particular embodiments only and is not intended to be limiting the disclosure. As used herein, the singular forms “a”, “an”, and “the” are intended to include the plural forms as well, unless the context indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any combinations of one or more of the associated listed items. It should be noted that the terms “mobile device”, “user equipment”, “user device”, “communication device”, “device” and similar terms are used interchangeably for the purpose of describing the invention. These terms are not intended to limit the scope of the invention or imply any specific functionality or limitations on the described embodiments. The use of these terms is solely for convenience and clarity of description. The invention is not limited to any particular type of device or equipment, and it should be understood that other equivalent terms or variations thereof may be used interchangeably without departing from the scope of the invention as defined herein.

As used herein, an “electronic device”, or “portable electronic device”, or “user device” or “communication device” or “user equipment” or “device” refers to any electrical, electronic, electromechanical, and computing device. The user device is capable of receiving and/or transmitting one or parameters, performing function/s, communicating with other user devices, and transmitting data to the other user devices. The user equipment may have a processor, a display, a memory, a battery, and an input-means such as a hard keypad and/or a soft keypad. The user equipment may be capable of operating on any radio access technology including but not limited to IP-enabled communication, Zig Bee, Bluetooth, Bluetooth Low Energy, Near Field Communication, Z-Wave, Wi-Fi, Wi-Fi direct, etc. For instance, the user equipment may include, but not limited to, a mobile phone, smartphone, virtual reality (VR) devices, augmented reality (AR) devices, laptop, a general-purpose computer, desktop, personal digital assistant, tablet computer, mainframe computer, or any other device as may be obvious to a person skilled in the art for implementation of the features of the present disclosure.

Further, the user device may also comprise a “processor” or “processing unit” includes processing unit, wherein processor refers to any logic circuitry for processing instructions. The processor may be a general-purpose processor, a special purpose processor, a conventional processor, a digital signal processor, a plurality of microprocessors, one or more microprocessors in association with a DSP core, a controller, a microcontroller, Application Specific Integrated Circuits, Field Programmable Gate Array circuits, any other type of integrated circuits, etc. The processor may perform signal coding data processing, input/output processing, and/or any other functionality that enables the working of the system according to the present disclosure. More specifically, the processor is a hardware processor.

As portable electronic devices and wireless technologies continue to improve and grow in popularity, the advancing wireless technologies for data transfer are also expected to evolve and replace the older generations of technologies. In the field of wireless data communications, the dynamic advancement of various generations of cellular technology are also seen. The development, in this respect, has been incremental in the order of second generation (2G), third generation (3G), fourth generation (4G), and now fifth generation (5G), and more such generations are expected to continue in the forthcoming time. In today's world, where communication and data transmission play an important role, network performance is crucial. Mobile network operators strive to provide their customers with optimal performance, seamless connectivity, and high-quality services.

Traditional methods of analyzing network performance relied on a combination of manual inspections, drive testing, key performance indicators (KPIs), network monitoring tools, field technicians and customer feedback. Although these methods provided valuable insights, they demanded significant time, resources, and manual labour. Drive testing required physically navigating different locations to collect data on network parameters, while KPIs and network monitoring tools provided quantitative measurements on a network-wide scale. On-site field technicians dealt with issues, and customer complaints provided feedback on network problems. However, these methods may not be sufficient to deliver real-time insights, cell-level analysis, or proactive issue identification.

The present disclosure discloses a system and method for analyzing real-time performance of at least one network cell. The present disclosure focuses on providing detailed network analysis of each individual cell, in order to optimize cellular network performance. The present disclosure extends its benefits to customer care support by integrating real-time cell-specific information into IVR communications. By enabling operators and support agents to proactively identify and address issues at the cell level, the solution aims to enhance overall network reliability and customer satisfaction, fostering a data-driven approach to decision-making for efficient resource allocation and continual network improvement.

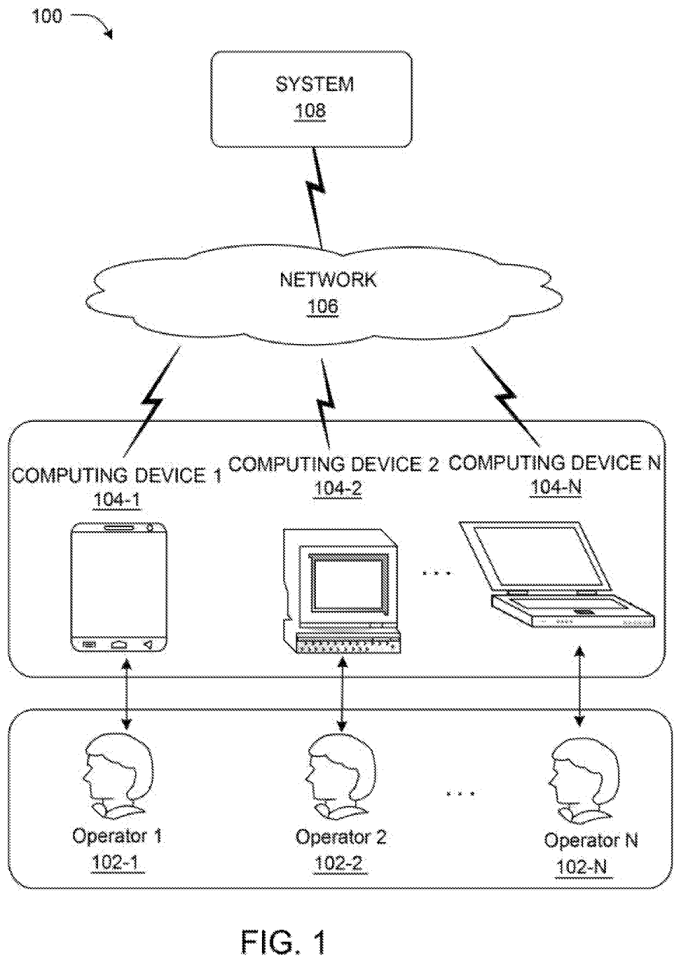

The various embodiments throughout the disclosure will be explained in more detail with reference to FIG. 1-FIG. 4.

FIG. 1 illustrates an exemplary network architecture (100) of a system (referred as “system 108”) for analyzing real-time performance of at least one network cell, in accordance with an embodiment of the present disclosure.

As illustrated in FIG. 1, one or more computing devices (104-1, 104-2 . . . 104-N) may be connected to the system (108) through a network (106). A person of ordinary skill in the art will understand that the one or more computing devices (104-1, 104-2 . . . 104-N) may be collectively referred as computing devices (104) and individually referred as a computing device (104). One or more operators (102-1, 102-2 . . . 102-N) may provide one or more requests to the system (108). A person of ordinary skill in the art will understand that the one or more operators (102-1, 102-2 . . . 102-N) may be collectively referred as operators (102) and individually referred as an operator (102).

In an embodiment, the computing device (104) may include, but not be limited to, a mobile, a laptop, etc. Further, the computing device (104) may include one or more in-built or externally coupled accessories including, but not limited to, a visual aid device such as a camera, audio aid, microphone, or keyboard. Furthermore, the computing device (104) may include a mobile phone, smartphone, virtual reality (VR) devices, augmented reality (AR) devices, a laptop, a general-purpose computer, a desktop, a personal digital assistant, a tablet computer, and a mainframe computer. Additionally, input devices for receiving input from the operator (102) such as a touchpad, touch-enabled screen, electronic pen, and the like may be used.

In an embodiment, the network (106) may include, by way of example but not limitation, at least a portion of one or more networks having one or more nodes that transmit, receive, forward, generate, buffer, store, route, switch, process, or a combination thereof, etc. one or more messages, packets, signals, waves, voltage or current levels, some combination thereof, or so forth. The network (106) may also include, by way of example but not limitation, one or more of a wireless network, a wired network, an internet, an intranet, a public network, a private network, a packet-switched network, a circuit-switched network, an ad hoc network, an infrastructure network, a Public-Switched Telephone Network (PSTN), a cable network, a cellular network, a satellite network, a fiber optic network, or some combination thereof.

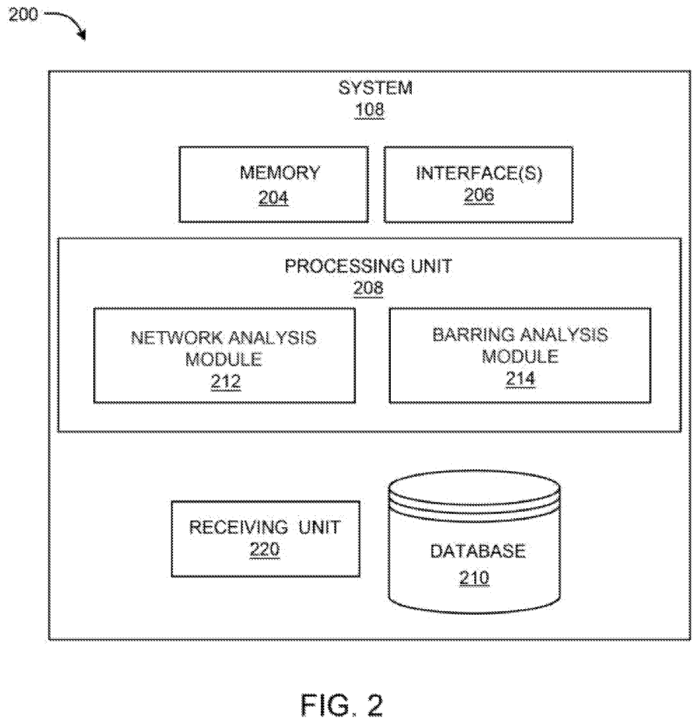

FIG. 2 illustrates an example block diagram (200) of the system (108), in accordance with an embodiment of the present disclosure.

Referring to FIG. 2, the system (108) includes a receiving unit 220, a memory 204, at least one source (not shown in FIG.), and a processing unit 208. The receiving unit 220 is configured to receive a location information of a user equipment (UE) using a location application programming interface (API). In an example, the location API may be associated with the UE. The location API is configured to separate a requesting application (for example, the receiving unit) from an infrastructure of the responding service and offer layers of security between the two (UE and the operator) as they communicate. Further, when the receiving unit 220 requests a user's location, which is provided via the location API, the user can then decide whether to allow or deny this request. In an aspect, the system is configured to receive a cell ID of a network cell where the UE presents manually from an operator via the receiving unit. In an embodiment, the system (108) is configured to capture or revise the cell ID of a customer or user during a call and pass it as input through the location API, by an interactive voice response (IVR) system.

The at least one source is configured to store a plurality of handover information and a plurality of signal quality metric information corresponding to the plurality of network cells. In an example, the at least one source is one of an operational support system (OSS), a unified data repository (UDR), and a plurality of network functions. For example, the plurality of network functions is a user data repository (UDR), or a Home Subscriber Server (HSS). In an embodiment, the handover information includes a number of handover attempts by each network cell. In an aspect, the plurality of signal quality metric information includes active barred site details, reference signal received power (RSRP), reference signal received quality (RSRQ), and signal-to-interference-plus-noise ratio (SINR). The RSRP is a parameter used in wireless communication systems to measure the quality of a received signal. The RSRP represents the power of a reference signal received by a receiver (UE), normalized to the power of a transmitted signal. A higher RSRP indicates a stronger signal, while a lower RSRP indicates a weaker signal. RSRP is commonly used to evaluate the quality of a received signal and estimate the amount of data that can be transmitted without errors. The UE usually measures RSRP or RSRQ based on the direction (RRC message) from the network and report the value. RSSI (received signal strength indicator) indicates the strength of the signal received by UE. RSSI considers not only the useful signal of a cell, but also all the secondary signal in the measured frequency range. For example, the RSSI value includes the signal of neighboring base stations, internal and external interference, and noise. SINR measures signal quality by comparing a strength of a required signal compared to the unnecessary interference and noise. Mobile network operators seek to maximize SINR at all sites to deliver the best possible customer experience, either by transmitting at a higher power, or by minimizing the interference and noise.

The memory 204 is configured to store a plurality of predefined cell identities (IDs) and a plurality of cell location information corresponding to a plurality of network cells. For example, a network cell has a cell ID number ABC having a location information of “XY town”. In an example, the location information includes a geographic location, latitude, and longitude information. The memory 204 is configured to store computer-readable instructions. The memory 204 may be coupled to the processing unit and may include any computer-readable medium known in the art including, for example, volatile memory, such as static random access memory (SRAM) and dynamic random access memory (DRAM) and/or non-volatile memory, such as read only memory (ROM), erasable programmable ROM, flash memories, hard disks, optical disks, and magnetic tapes.

The processing unit 208 is configured to cooperate with the receiving unit, the memory and the at least one source. The processing unit 208 is further configured to retrieve a cell ID corresponding to a network cell associated with the user equipment by using the received location information of the user equipment and the stored plurality of cell location information. The processing unit 208 is configured to identify at least one neighboring cell to the network cell associated with the user equipment, by utilizing a handover information corresponding to the retrieved cell ID. The processing unit 208 is configured to analyze a plurality of performance attributes associated with the at least one neighboring cell and the network cell of the retrieved cell ID, by utilizing the plurality of signal quality metric information associated with the neighboring cells and the network cell of the retrieved cell ID. In an example, the plurality of performance attributes is selected from a group of consisting of barring, outage, congestion, and interference. The performance attributes are crucial for evaluating the reliability, efficiency, and quality of a telecommunications network. Telecommunications performance attributes encompass a range of factors crucial for evaluating network quality and reliability. These attributes include throughput, latency, packet loss, jitter, and availability. Throughput measures the amount of data transmitted over the network within a given time, indicating its capacity and efficiency. Latency refers to the time it takes for data to travel from the source to the destination, affecting the responsiveness of applications and user experience. Packet loss signifies the percentage of data packets that fail to reach their destination, impacting the reliability of communication. Jitter represents the variation in latency, affecting the consistency of data transmission and real-time applications. Availability denotes the percentage of time the network is operational and accessible, reflecting its reliability and uptime. Monitoring and optimizing these performance attributes are essential for ensuring a high-performing and resilient network infrastructure. One such factor (attribute) is “barring,” which restricts network access for certain devices or users, often for security or capacity reasons. Another performance attribute is “outages,” which refers to periods where the network is unavailable, typically due to equipment failure or maintenance. In addition, “congestion” represents another performance attribute that arises due to excessive demand for network resources, leading to slow performance or disruption during peak usage. “Interference” attribute occurs when unwanted signals disrupt data transmission, originating from sources like other devices or environmental factors. Monitoring and managing these performance attributes are vital for ensuring optimal network performance and user satisfaction in wireless communication systems. By ensuring that these attributes are well-maintained, network providers can provide reliable and high-quality services to their customers, leading to better user experiences and customer retention.

According to an aspect of the present disclosure, the processing unit 208 may be implemented as one or more microprocessors, microcomputers, microcontrollers, digital signal processors, central processing units, state machines, logic circuitries, and/or any devices that manipulate signals based on operational instructions. Among other capabilities, the processing unit may be configured to fetch and execute computer-readable instructions stored in the memory.

In an operative aspect, the system (108) is configured to determine at least one operative state of the network cell of the retrieved cell ID based on the analyzed plurality of the performance attributes. In an example, the at least one operative state is a congested state, a barred state, an outage state, a congested state, and an interference state.

In an example, the system is configured to store the at least one at least one determined operative state and the plurality of analyzed performance attributes in the memory along with a time stamp.

For determining the barred state, the processing unit (208) is configured to map the retrieved cell ID with a list having cell IDs corresponding to barred network cells in a network. In an aspect, the list having cell IDs corresponding to the barred network cells stored in the memory. Further, for determining the outage state, the processing unit (208) is configured to map the retrieved cell ID with a list having cell IDs having active outage in the network stored in the memory. Furthermore, for determining the congested state, the processing unit (208) is configured to map the retrieved cell ID with a list having cell IDs corresponding to congested network cells in the network stored in the memory.

For determining the interference state, the processing unit (208) is configured to map the retrieved cell ID with a list having cell IDs having interference stored in the memory.

In an embodiment, the system (108) is configured to examine performance attributes (network aspects) of the received cell ID and identified neighbors, including barring, congestion, outage, and interference.
(a) Barring: the system (108) utilizes active barred sites details to determine if the identified cells have barring, providing a verdict of full barring if all identified cells have barring and partial barring if only some of the identified cells have barring.
(b) Outage: The system (108) checks active outage alarms to determine if there is a live outage in the surrounding area, issuing a verdict of full outage if all identified cells are experiencing an outage and partial outage if only some of the identified cells have outage alarms.
(c) Congestion: The system (108) refers to a consistently reported list of highly congested cells from the past 7 days, providing a verdict of full congestion if all identified cells are in the list and partial congestion if only some of the identified cells are congested.
(d) Interference: The system (108) examines active interference alarms to determine if there is interference in the surrounding area, providing a verdict of full interference if all identified cells have interference and partial interference if only some of the identified cells have interference.

In an aspect, the system is further configured to determine an extent of the at least one determined operative state and provides a network cell recovery verdict (at least one resolution) corresponding to the at least one determined operative state based on the determined extent. The system (108) is configured to provide the at least one resolution by considering at least one or more of the at least one operative state, historical data representing reoccurrence of the at least one operative state, and current network conditions.

In an aspect, the at least one resolution may be a transferring a call associated with the UE from a present network cell to a neighboring network cell. In an embodiment, the system is configured to analyse the determined operative states of the plurality of network cells and the plurality of analyzed performance attributes to suggest the at least one resolution.

In an embodiment, the system (108) may include an interface(s) (206). The interface(s) (206) may comprise a variety of interfaces, for example, interfaces for data input and output devices (I/O), storage devices, and the like. The interface(s) (206) may facilitate communication through the system (108). The interface(s) (206) may also provide a communication pathway for one or more components of the system (108). Examples of such components include, but are not limited to, processing unit (208) and a database (210). Further, the processing unit (208) further includes a network analysis module (212), a barring analysis module (214), and other engine(s). In an embodiment, the other engine(s) may include, but not limited to, a data ingestion engine, an input/output engine, and a notification engine.

In an embodiment, the processing unit (208) may be implemented as a combination of hardware and programming (for example, programmable instructions) to implement one or more functionalities of the processing unit (208). In examples described herein, such combinations of hardware and programming may be implemented in several different ways. For example, the programming for the processing unit (208) may be processor-executable instructions stored on a non-transitory machine-readable storage medium and the hardware for the processing unit (208) may comprise a processing resource (for example, one or more processors), to execute such instructions. In the present examples, the machine-readable storage medium may store instructions that, when executed by the processing resource, implement the processing unit (208). In such examples, the system may comprise the machine-readable storage medium storing the instructions and the processing resource to execute the instructions, or the machine-readable storage medium may be separate but accessible to the system and the processing resource. In other examples, the processing unit (208) may be implemented by electronic circuitry.

In an embodiment, the processing unit (208) identifies a specific cell ID associated with a customer's call (location of the UE) and extracts it for further analysis. By passing the captured cell ID through the location API, the processing unit (208) is configured to perform a number of steps of analyzing the network performance based on this specific cell ID. The location API serves as a means of transferring the cell ID data to the subsequent stages of the network analysis process. This embodiment ensures that the necessary information regarding the customer's cell ID is seamlessly integrated into the overall system for accurate and efficient network performance analysis.

In an embodiment, the processing unit (208) identifies top neighboring cells by the network analysis module (212), based on number of handover attempts and determines the nearest surrounding cells of the provided cell ID. Also, the processing unit (208) examines the network aspects of the received cell ID and identified neighbors, including barring, congestion, outage, and interference.

In an embodiment, the processing unit (208) utilizes active barred sites details, by the barring analysis module (214) to determine if the identified cells have barring, providing a verdict of full barring if all identified cells have barring and partial barring if only some of the identified cells have barring. By utilizing the active barred sites details, the processor and the barring analysis module evaluate each identified cell to ascertain if it is subject to any form of barring. If all of the identified cells have barring restrictions, the verdict is determined as “full barring,” indicating that there is complete restriction or prohibition in the surrounding area. However, if only some of the identified cells exhibit barring while others do not, the verdict is determined as “partial barring.” This verdict suggests that there is a mixture of cells with and without barring restrictions in the surrounding area.

In an embodiment, the processing unit (208) employs RSRP mapping data based on a planning tool to evaluate the coverage quality, providing an extent of the coverage state. In an aspect, the extent of the coverage state can be classified as “excellent,” “good,” “poor,” and “bad,” depending on the range in which the measured RSRP values fall. These classifications provide an indication of the signal strength and coverage experience that customers can expect in the surrounding area.

Moreover, by employing the RSRP mapping data the processor can assess the coverage quality of the identified cells, enabling network operators to understand the level of signal strength and coverage available in specific areas of their network. This information is valuable for identifying coverage gaps and taking appropriate actions to optimize network performance and improve the customer experience.

In an embodiment, the processing unit (208) may be configured to check active outage alarms to determine if there is a live outage in the surrounding area, and issuing a verdict of full outage if all identified cells are experiencing an outage and partial outage if only some of the identified cells have outage alarms. Additionally, the processing unit (208) refers to a consistently reported list of highly congested cells from the past 7 days, providing a verdict of full congestion if all identified cells are in the list and partial congestion if only some of the identified cells are congested. Furthermore, the processing unit (208) examines active interference alarms to determine if there is interference in the surrounding area, providing a verdict of full interference if all identified cells have interference and partial interference if only some of the identified cells have interference.

Further, the processing unit (208) generates an issue report based on the network analysis, including the identified issues, their corresponding resolutions, and an estimated time of arrival (ETA). The processing unit (208) also enables the IVR system to provide accurate and relevant communications to customers regarding their network issues and their corresponding resolutions, reducing the number of calls to the care agent and the mean holding time that enhances operator trust by demonstrating their awareness of customer issues and their proactive efforts to track and resolve them, thereby improving customer satisfaction. Additionally, the system (100) decreases number of calls to the care agent and the mean holding time, ultimately reducing costs for the company, and extends the network analysis capabilities to customer care support, allowing care agents to access the analysis results and provide appropriate assistance to customers.

In an embodiment, the system (108) includes a display unit configured to display the at least one determined operative state of the network cell and the suggested at least one resolution.

Further, the system (108) may be configured to generate an issue report based on the network analysis, including the identified issues, their corresponding resolutions, and an estimated time of arrival (ETA).

Although FIG. 2 shows exemplary components of the system (108), in other embodiments, the system (108) may include fewer components, different components, differently arranged components, or additional functional components than depicted in FIG. 2. Additionally, or alternatively, one or more components of the system (108) may perform functions described as being performed by one or more other components of the system (108).

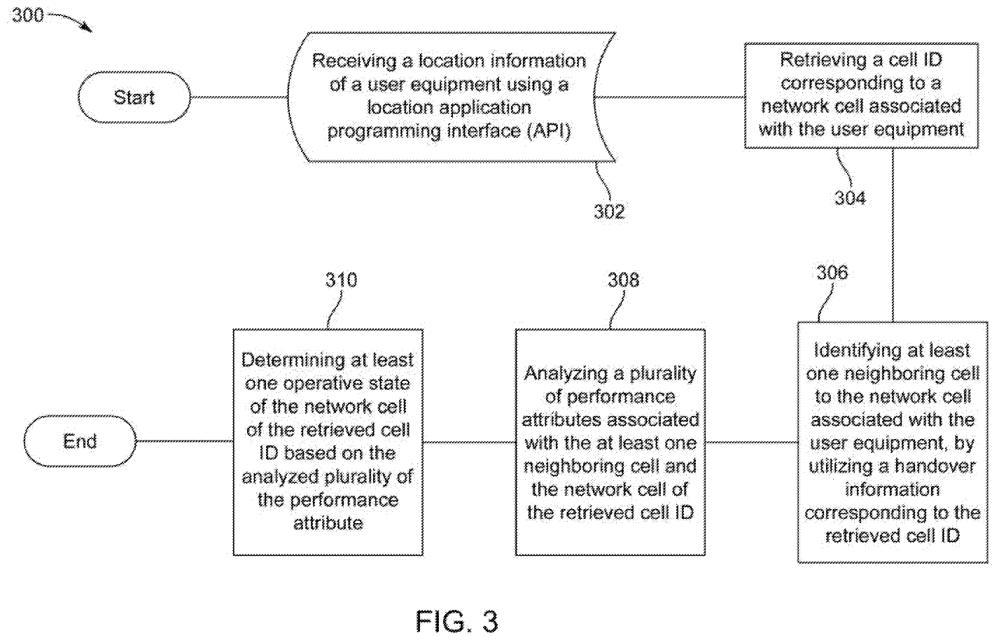

FIG. 3 illustrates an example flow diagram (300) for analyzing real-time performance of at least one network cell, in accordance with an embodiment of the present disclosure.

At step (302), the system (108) receives location information of a user equipment using a location application programming interface (API). In an example, the system (108) is configured to receive cell ID as input feed by a care agent through URL parameter. The step (302) further includes storing a plurality of cell IDs along and a plurality of locations corresponding to a plurality of network cells. The step (302) further includes storing a plurality of handover information and a plurality of signal quality metric information corresponding to the plurality of network cells. In an embodiment, the method further includes a step of receiving the cell ID manually from an operator.

At step (304), the system (108) is configured to retrieve a cell ID corresponding to a network cell associated with the user equipment by using the received location information of the user equipment and the stored plurality of cell location information.

At step (306), the system (108) is configured to identify at least

one neighboring cell to the network cell associated with the user equipment, by utilizing a handover information corresponding to the retrieved cell ID.

At step (308), the system (108) is configured to analyze a plurality of performance attributes associated with the at least one neighboring cell and the network cell of the retrieved cell ID, by utilizing the plurality of signal quality metric information associated with the neighboring cells and the network cell of the retrieved cell ID. At step (308), the system (108) is configured to analyse the cell in different network aspect like barring, congestion, outage, and intersection in back end. The step (308) further includes analysing network and providing details of each network aspect and provide a verdict including any of excellent, good, poor, and bad, along with resolution if any with its estimated time of arrival (ETA).

At step (310), the system (108) is configured to determine at least one operative state of the network cell of the retrieved cell ID based on the plurality of analyzed performance attributes. The step (310) further includes providing verdict based on analysis for issue identified if any with information about the issue's resolution and ETA. The step (310) further includes determining an extent of the at least one determined operative state and provides a network cell recovery verdict based on the determined extent. In an embodiment, the step (310) further includes suggesting at least one resolution corresponding to the at least one determined operative state of the network cell. In another embodiment, the method further includes a step of displaying the at least one determined operative state of the network cell and the suggested at least one resolution on a display unit.

By employing the step (310), the system is configured to establish a trust with the customer by demonstrating that the operator is aware of the issues and is actively working towards resolving them. By providing transparency and keeping track of the issues, the operator aims to improve customer satisfaction.

In an embodiment, the method further includes a step of storing the at least one determined operative state and the plurality of analyzed performance attributes in the memory along with a time stamp.

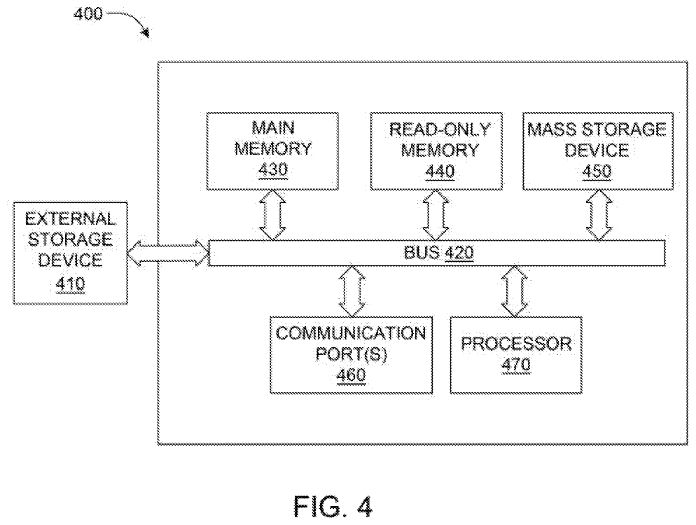

In an exemplary embodiment, the present disclosure discloses a user equipment which is configured to analyze real-time performance of at least one network cell. The user equipment includes a processor, and a computer readable storage medium storing programming instructions for execution by the processor. Under the programming instructions, the processor receives a location information of the user equipment using a location application programming interface (API). Under the programming instructions, the processor stores a plurality of cell IDs along and a plurality of locations corresponding to a plurality of network cells in the computer readable storage medium memory. The processor retrieves a cell ID corresponding to a network cell associated with the user equipment by using the received location information of the user equipment and the stored plurality of cell location information. The processor is configured to identify at least one neighboring cell to the network cell associated with the user equipment, by utilizing a handover information corresponding to the retrieved cell ID stored in at least one source. The at least one source further stores a plurality of signal quality metric information corresponding to the plurality of network cells. The processor is configured to analyze a plurality of performance attributes associated with the at least one neighboring cell and the network cell of the retrieved cell ID, by utilizing the plurality of signal quality metric information associated with the neighboring cells and the network cell of the retrieved cell ID. FIG. 4 illustrates an example computer system (400) in which or

with which the embodiments of the present system (108) may be implemented.

As shown in FIG. 4, the computer system (400) may include an external storage device (410), a bus (420), a main memory (430), a read-only memory (440), a mass storage device (450), a communication port(s) (460), and a processor (470). A person skilled in the art will appreciate that the computer system (400) may include more than one processor and communication ports. The processor (470) may include various modules associated with embodiments of the present disclosure. The communication port(s) (460) may be any of an RS-232 port for use with a modem-based dialup connection, a 10/100 Ethernet port, a Gigabit or 10 Gigabit port using copper or fiber, a serial port, a parallel port, or other existing or future ports. The communication ports(s) (460) may be chosen depending on a network, such as a Local Area Network (LAN), Wide Area Network (WAN), or any network to which the computer system connects.

In an embodiment, the main memory (430) may be Random Access Memory (RAM), or any other dynamic storage device commonly known in the art. The read-only memory (440) may be any static storage device(s) e.g., but not limited to, a Programmable Read Only Memory (PROM) chip for storing static information e.g., start-up or basic input/output system (BIOS) instructions for the processor (470). The mass storage device (450) may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces).

In an embodiment, the bus (420) may communicatively couple the processor(s) (470) with the other memory, storage, and communication blocks. The bus (420) may be, e.g. a Peripheral Component Interconnect PCI)/PCI Extended (PCI-X) bus, Small Computer System Interface (SCSI), Universal Serial Bus (USB), or the like, for connecting expansion cards, drives, and other subsystems as well as other buses, such a front side bus (FSB), which connects the processor (470) to the computer system (400).

In another embodiment, operator and administrative interfaces, e.g., a display, keyboard, and cursor control device may also be coupled to the bus (420) to support direct operator interaction with the computer system (400). Other operator and administrative interfaces can be provided through network connections connected through the communication port(s) (460). Components described above are meant only to exemplify various possibilities. In no way should the aforementioned exemplary computer system (400) limit the scope of the present disclosure.

The present disclosure discloses a user equipment configured to analyze real-time performance of at least one network cell. The user equipment includes a processor and a computer readable storage medium storing programming instructions for execution by the processor. Under the programming instructions, the processor is configured to receive a location information of the user equipment using a location application programming interface (API). Under the programming instructions, the processor is configured to store, in the computer readable storage medium, a plurality of cell IDs along and a plurality of locations corresponding to a plurality of network cells. Under the programming instructions, the processor is configured to retrieve, by the processor, a cell ID corresponding to a network cell associated with the user equipment by using the received location information of the user equipment and the stored plurality of cell location information. Under the programming instructions, the processor is configured to identify, by the processor, at least one neighboring cell to the network cell associated with the user equipment, by utilizing a handover information corresponding to the retrieved cell ID stored in at least one source, wherein the at least one source further stores a plurality of signal quality metric information corresponding to the plurality of network cells. Under the programming instructions, the processor is configured to analyze, by the processor, a plurality of performance attributes associated with the at least one neighboring cell and the network cell of the retrieved cell ID, by utilizing the plurality of signal quality metric information associated with the neighboring cells and the network cell of the retrieved cell ID.

The present disclosure is configured to provide an enhancement to the customer care services. The system (108) enables the IVR system to provide accurate and relevant communications to customers regarding their network issues and their corresponding resolutions, reducing the number of calls to the care agent and the mean holding time. This enhances operator trust by demonstrating their awareness of customer issues and their proactive efforts to track and resolve them, thereby improving customer satisfaction. Also, decreases the number of calls to the care agent and the mean holding time, reducing costs for the company, and allowing care agents to access the analysis results and provide appropriate assistance to customers. The present disclosure is applicable to a wide range of applications that require real-time performance tracking of the network cell in real time. With the fast advances of 5G standardization, the present disclosure may be applicable to performance-based services-related use cases.

The method and system of the present disclosure may be implemented in a number of ways. For example, the methods and systems of the present disclosure may be implemented by software, hardware, firmware, or any combination of software, hardware, and firmware. The above-described order for the steps of the method is for illustration only, and the steps of the method of the present disclosure are not limited to the order specifically described above unless specifically stated otherwise. Further, in some embodiments, the present disclosure may also be embodied as programs recorded in a recording medium, the programs including machine-readable instructions for implementing the methods according to the present disclosure. Thus, the present disclosure also covers a recording medium storing a program for executing the method according to the present disclosure.

While considerable emphasis has been placed herein on the preferred embodiments, it will be appreciated that many embodiments can be made and that many changes can be made in the preferred embodiments without departing from the principles of the disclosure. These and other changes in the preferred embodiments of the disclosure will be apparent to those skilled in the art from the disclosure herein, whereby it is to be distinctly understood that the foregoing descriptive matter is to be implemented merely as illustrative of the disclosure and not as a limitation.

### Advantages of the Invention

The present disclosure provides a system and a method that automates the network analysis process, resulting in significant time and resource savings compared to manual inspections, drive testing, and field technician visits. Furthermore, the analysis is conducted in real-time, enabling proactive identification and resolution of issues.

The present disclosure provides a system and a method that specifically focuses on evaluating the performance of individual cells, and this cell-level analysis allows for a more detailed understanding of network issues, facilitating targeted optimizations and improvements.

The present disclosure provides a system and a method that is capable of identifying probable serving cells and analyzing various network parameters. By proactively detecting issues and monitoring factors such as barring, outage, congestion, and interference, potential problems can be identified before they negatively impact network performance or customer experience.

The present disclosure provides a system and a method that equips agents with accurate and up-to-date information regarding network issues and their resolutions. This empowers agents to deliver timely and relevant assistance to customers, reducing the volume of calls to the care centre and enhancing customer satisfaction.

The present disclosure provides a system and a method that automates the network analysis process, enabling proactive issue identification, and the system helps decrease operational costs by minimizing the need for manual inspections, drive testing, and field technician visits, resulting in cost savings for the network operator.

1. A system for analyzing real-time performance of at least one network cell, said system comprising:
a receiving unit configured to receive a location information of a user equipment using a location application programming interface (API);
a memory configured to store a plurality of predefined cell identities (IDs) and a plurality of cell location information corresponding to a plurality of network cells;
at least one source configured to store a plurality of handover information and a plurality of signal quality metric information corresponding to said plurality of network cells; and
a processing unit configured to cooperate with said receiving unit, said memory, and said at least one source, and said processing unit is further configured to:
retrieve a cell ID corresponding to a network cell associated with said user equipment by using said received location information of said user equipment and said stored plurality of cell location information;
identify at least one neighboring cell to said network cell associated with said user equipment, by utilizing a handover information corresponding to said retrieved cell ID; and
analyze a plurality of performance attributes associated with said at least one neighboring cell and said network cell of said retrieved cell ID, by utilizing said plurality of signal quality metric information associated with said neighboring cells and said network cell of said retrieved cell ID.

2. The system as claimed in claim 1, wherein said plurality of performance attributes include barring, outage, congestion, and interference.

3. The system as claimed in claim 1, is further configured to determine at least one operative state of said network cell of said retrieved cell ID based on said analyzed plurality of performance attributes.

4. (canceled)

5. The system as claimed in claim 3, is further configured to determine an extent of said at least one determined operative state and provide at least one resolution corresponding to said at least one determined operative state based on said determined extent, wherein said at least determined one operative state is a congested state, a barred state, an outage state, and an interference state.

6. The system as claimed in claim 5, wherein for determining said barred state, the processing unit is configured to map said retrieved cell ID with a list having cell IDs corresponding to barred network cells in a network.

7. The system as claimed in claim 5, wherein for determining said outage state, the processing unit is configured to map said retrieved cell ID with a list having cell IDs having active outage in said network stored in said memory.

8. The system as claimed in claim 5, wherein for determining said congested state, the processing unit is configured to map said retrieved cell ID with a list having cell IDs corresponding to congested network cells in said network stored in said memory.

9. The system as claimed in claim 5, wherein for determining said interference state, the processing unit is configured to map said retrieved cell ID with a list having cell IDs having interference stored in said memory.

10. The system as claimed in claim 1, is configured to provide said at least one resolution by considering at least one or more of said at least one operative state, historical data representing reoccurrence of said at least one operative state, and current network conditions.

11. The system as claimed in claim 1, wherein said handover information includes a number of handover attempts by said retrieved cell ID.

12. The system as claimed in claim 1, wherein said at least one source is one of an operational support system (OSS), a unified data repository (UDR), and a plurality of network functions.

13. The system as claimed in claim 1, wherein said plurality of signal quality metric information includes active barred site details, reference signal received power (RSRP), reference signal received quality (RSRQ), and signal-to-interference-plus-noise ratio (SINR).

14. (canceled)

15. (canceled)

16. A method of analyzing real-time performance of at least one network cell, said method comprising:
receiving a location information of a user equipment using a location application programming interface (API);
retrieving a cell ID corresponding to a network cell associated with said user equipment by using said received location information of said user equipment and a plurality of cell location information stored in a memory;
identifying at least one neighboring cell to said network cell associated with said user equipment, by utilizing a handover information corresponding to said retrieved cell ID; and
analyzing a plurality of performance attributes associated with said at least one neighboring cell and said network cell of said retrieved cell ID, by utilizing said plurality of signal quality metric information associated with said neighboring cells and said network cell of said retrieved cell ID.

17. The method as claimed in claim 16, further comprising determining (310) at least one operative state of said network cell of said retrieved cell ID based on said plurality of analyzed performance attributes.

18. The method as claimed in claim 17, further comprising determining an extent of said at least one determined operative state and provides at least one resolution corresponding to said at least one determined operative state based on said determined extent, wherein said at least determined one operative state is a congested state, a barred state, an outage state, and an interference state.

19. The method as claimed in claim 16, further comprising storing a plurality of handover information and a plurality of signal quality metric information corresponding to said plurality of network cells in at least one source.

20. The method as claimed in claim 19, wherein said handover information includes a number of handover attempts by said retrieved cell ID.

21. (canceled)

22. The method as claimed in claim 19, wherein said plurality of signal quality metric information includes active barred site details, reference signal received power (RSRP), reference signal received quality (RSRQ), and signal-to-interference-plus-noise ratio (SINR).

23. (canceled)

24. (canceled)

25. (canceled)

26. (canceled)

27. A computer program product comprising a non-transitory computer-readable medium comprising instructions that, when executed by one or more processors, cause said one or more processors to:
receive a location information of a user equipment using a location application programming interface (API);
store a plurality of cell IDs along and a plurality of locations corresponding to a plurality of network cells;
store a plurality of handover information and a plurality of signal quality metric information corresponding to said plurality of network cells;
retrieve a cell ID corresponding to a network cell associated with said user equipment by using said received location information of said user equipment and said stored plurality of cell location information;
identify at least one neighboring cell to said network cell associated with said user equipment, by utilizing a handover information corresponding to said retrieved cell ID; and
analyze a plurality of performance attributes associated with said at least one neighboring cell and said network cell of said retrieved cell ID, by utilizing said plurality of signal quality metric information associated with said neighboring cells and said network cell of said retrieved cell ID.

28. A user equipment configured to analyze real-time performance of at least one network cell, said user equipment comprising:
a processor; and
a computer readable storage medium storing programming for execution by said processor, the programming including instructions to:
receive a location information of said user equipment using a location application programming interface (API);
store, in said computer readable storage medium, a plurality of cell IDs along and a plurality of locations corresponding to a plurality of network cells;
retrieve, by said processor, a cell ID corresponding to a network cell associated with said user equipment by using said received location information of said user equipment and said stored plurality of cell location information;
identify, by said processor, at least one neighboring cell to said network cell associated with said user equipment, by utilizing a handover information corresponding to said retrieved cell ID stored in at least one source, wherein said at least one source further stores a plurality of signal quality metric information corresponding to said plurality of network cells; and
analyze, by said processor, a plurality of performance attributes associated with said at least one neighboring cell and said network cell of said retrieved cell ID, by utilizing said plurality of signal quality metric information associated with said neighboring cells and said network cell of said retrieved cell ID.
